(19) United States
(12) Patent Application Publication
(10) Pub. No.: US 2017/0298697 A1
(43) Pub. Date: Oct. 19, 2017

(54) Linear Brushless Contact Slip For High Pressure and High Temperature Downhole Application

(71) Applicant: Halliburton Energy Services, Inc., Houston, TX (US)

(72) Inventor: Kar Ki Loh, Singapore (SG)

(21) Appl. No.: 15/518,061

(22) PCT Filed: Nov. 18, 2014
(86) PCT No.: PCT/US2014/066121

§ 371 Date: Apr. 10, 2017

(51) Int. Cl. E21B 17/02; E21B 17/00; E21B 17/05; H01R 41/00

(52) U.S. Cl. CPC E21B 17/028; H01R 41/00; E21B 17/003; E21B 17/05

(57) ABSTRACT

A linear electrical contact slip structure for conducting electricity between two regions of a tool string while deployed within a wellbore. The linear electrical contact slip maintains an electrical connection between a piston structure and a collar structure, where either structure can be a stroker section or a stator section, and where the electrical connection is maintained when the stoker section is either stationary or in motion. The electrical connections between the piston and collar are grouped along the interior hollow surface of the collar, corresponding to contacts on the exterior of the piston head. The piston and collar are configured to prevent relative rotational motion, but to allow relative linear motion, by use of projections from the piston that match grooves in the collar.

### TECHNICAL FIELD

This disclosure relates to apparatus and systems for forming electrical connections, for either or both of conducting electricity and transmitting signals, between regions of a tool string deployed in hydrocarbon wells and other wells.

### BACKGROUND

In conventional wellbore or reservoir fluidic systems, a rotating slip ring can be used to transmit electrical current or signal from one region of a tool string to another region of a tool string deployed within a wellbore. The rotation of the slip ring, and in particular the contact of “brushes” between the rotating structure and non-rotating structure where the slip ring is located on the tool string, allows for the transmission of electricity across elements which are not necessarily moving in the same direction as each other. Traditionally, electrical connections to conductive elements such as brushes in a slip ring can be subject to tension and wear, particularly in high temperature or high pressure environments. Further, such structures can be isolated from the wellbore environment, requiring additional pressure control for the structure.

### BRIEF DESCRIPTION OF THE DRAWINGS

Illustrative aspects of the present disclosure are described in detail below with reference to the following drawing figures.

FIG. 1-1 is a schematic diagram of a well drilling system having a linear electrical contact slip, according to some aspects of the present disclosure.

FIG. 1-2 is a schematic diagram of a well drilling system having a linear electrical contact slip, according to alternative aspects of the present disclosure.

FIG. 2A is a side-view cross-sectional schematic diagram of a linear electrical contact slip having an exterior collar structure and an interior piston structure, according to some aspects of the present disclosure.

FIG. 2B is an illustration of a piston structure as shown in FIG. 2A, having an electrical contact head on one end of the piston structure, according to some aspects of the present disclosure.

FIG. 2C is an illustration of a piston structure as shown in FIG. 2A, having an electrical contact head on each end of the piston structure, according to some aspects of the present disclosure.

FIG. 3 is a schematic illustration of an electrical contact head and electrical contact element in relation to a conductive coil mounted within a collar structure, according to some aspects of the present disclosure.

FIG. 4A is an end-view cross-sectional schematic diagram of a collar structure of a linear electrical contact slip configured to receive three groupings of three electrical contacts each, according to some aspects of the present disclosure.

FIG. 4B is an end-view cross-sectional schematic diagram of a piston structure of a linear electrical contact slip configured to have three groupings of three electrical contacts each, according to some aspects of the present disclosure.

FIG. 5A is an end-view cross-sectional schematic diagram of a collar structure of a linear electrical contact slip configured to receive four groupings of two electrical contacts each, according to some aspects of the present disclosure.

FIG. 5B is an end-view cross-sectional schematic diagram of a piston structure of a linear electrical contact slip configured to have four groupings of two electrical contacts each, according to some aspects of the present disclosure.

FIG. 6A is an end-view cross-sectional schematic diagram of a collar structure of a linear electrical contact slip configured to receive three groupings of two electrical contacts each, according to some aspects of the present disclosure.

FIG. 6B is an end-view cross-sectional schematic diagram of a piston structure of a linear electrical contact slip configured to have three groupings of two electrical contacts each, according to some aspects of the present disclosure.

FIG. 7A is an end-view cross-sectional schematic diagram of a collar structure of a linear electrical contact slip configured to receive three groupings of four electrical contacts each, according to some aspects of the present disclosure.

FIG. 7B is an end-view cross-sectional schematic diagram of a piston structure of a linear electrical contact slip configured to have three groupings of four electrical contacts each, according to some aspects of the present disclosure.

### DETAILED DESCRIPTION

Certain aspects of the present disclosure relate to an electrical connection structure for a tool string, mandrel, or other such tubing apparatus deployed in a wellbore environment. As disclosed herein, a linear contact slip structure can include a collar and a piston, where the collar and piston are configured to move linearly in relation to each other, where one of either the collar or piston is the stator (static) section and the other is the stroker (dynamic) section. Each of the collar and piston have electrical contacts arranged to align such that an electrical connection is maintained between the stator section and the stroker section as either of the piston or collar move in a linear direction. Further, the structure of the piston includes a set of key projections extending outward from the longitudinal axis of the piston which match and couple with keyway grooves or channels in the collar structure, thereby maintaining a relative linear motion between the piston and collar without significant relative rotational motion between the two structures. The configuration of the collar and piston allow for an electrical connection between two regions of a tool string without the use either of brushes or a closed section as commonly known and used with rotary slip rings in the industry. Moreover, the linear motion of the electrical contact slip disclosed herein provides both for the use of wiring that does not require an amount of slack in the wire that can be physically challenging to accommodate and for a dynamic motion that avoids a degree of deformation wear that can damage such wiring.

In many applications, the control of pressure on tools, sensors, or other apparatus along a tool string when deployed within a wellbore can be critical to maintain the operability of such tools, sensors, or apparatus. In some structures, a closed or pressure-isolated system is required to ensure operation of internal structures, such as electrical connections. In aspects of the present disclosure, the linear electrical contact slip has a collar structure which is hollow to receive and provide a range of motion for a piston. Such a structure can accordingly be also exposed or open to the surrounding wellbore environment, including the fluids, temperatures, and pressures within the wellbore. As the linear electrical contact slip of the present disclosure does not have a need to maintain a specifically controlled pressure for the operation of the electrical connections between a piston and collar, the linear electrical contact slip structure can function in relatively higher pressure environments than rotary contact slips known in the industry which need a closed, pressure-controlled system or contact interface.

In further applications, the amount of wiring required for an electrical connection between two regions of a tool string deployed in a wellbore needs to include a length of slack to account for either or rotational and linear motion of either or both of the two regions of the tool string. For example, with a rotary contact slip that can travel a distance along the length of a tool string concurrently with rotating around a tool string, the amount of slack required in the wiring can cause the wiring to have a length equivalent to 150% or more of the linear distance the rotary contact slip can move. The amount of slack in the wiring can thereby add complexity to the tool string or rotary contact slip structure, increasing the volume of a structure holding the wiring in either or both of length or width (which can increase the diameter of the tool string as a whole).

In alternative aspects of the present disclosure, either the piston or the collar of the linear electrical contact slip can be the stroker section, with the complementary structure being the stator section in a given aspect. In other words, aspects of the present disclosure can be constructed and operated to have the piston be the stroker section (i.e. the moving, dynamic structure) while the collar is the stator section (i.e. a static structure) of the linear electrical contact slip. Conversely, aspects of the present disclosure can be constructed and operated to have the collar be the stroker section (i.e. the moving, dynamic structure) while the piston is the stator section (i.e. a static or stationary structure) of the linear electrical contact slip. The determination to configure either the piston of the collar of the linear electrical contact slip as the stroker can be based on the individual design requirements of a tool string or environmental conditions of a wellbore. In further aspects, the linear electrical contact slip can be configured to switch the function and motion of either or both of the collar and piston when deployed downhole. In other words, a tool string with a linear electrical contact slip can be deployed in a wellbore with the piston configured to be the stroker section and the collar configured to be the stator section, and while deployed, the linear electrical contact slip can be controlled to switch the piston to be the stator section and the collar to be the stroker section, or vice versa.

Further aspects of the present disclosure provide for a scalable structure, due in part to the linear configuration of the components. In some aspects, the linear electrical contact slips described herein can have an overall diameter (equivalent to the diameter of the collar structure) of from about one-and-a-half to about four inches (1.5″-4″). In other aspects, the linear electrical contact slips described herein can have an overall diameter that is greater than four inches (>4″). The number of contacts between a stator section and a stroker section can be determined by the diameter of any given linear electrical contact slip. In contrast, rotary slip rings as known in the industry can be limited in gauge or diameter. Similarly, the linear electrical contact slips described herein can be constructed to have an overall length that meets a needed or desired length of extension within a wellbore. In some aspects, a linear electrical contact slip can have a length of from about five inches to about forty inches (5″-40″) when retracted, i.e. the position where the piston structure is most surrounded by the collar structure, and the linear electrical contact slip is at its shortest. In other aspects, a linear electrical contact slip can have a length that is greater than forty inches (>40″) when retracted. When extended, i.e. at the position where the piston structure is least surrounded by the collar structure, and the linear electrical contact slip is at its longest, a linear electrical contact slip can have a length of extension where the extension ratio is 1:1 In other words, the stator section and the stroker section can be of equal length such that the length of the linear electrical contact slip when fully extended is double the length of the linear electrical contact slip when retracted. Accordingly, a linear electrical contact slip having a retracted length of about five inches (5″) would have an extended length of about ten inches (10″). Similarly, a linear electrical contact slip having a retracted length of about forty inches (40″) would have an extended length of about eighty inches (80″). In some aspects, the rate at which the linear electrical contact slip can extend or retract the stroker section can be about five inches per second (5″/sec).

In further contrast to rotary slip rings as known in the industry, the linear electrical contact slip of the present disclosure provides for a structure that reduces debris formation. The rotation of rotary slip rings when deployed downhole can lead to the formation of debris due to the friction and motion of a rotary slip ring with surrounding earth strata. Such debris can settle, wedge, or reside in between the casing of a rotary slip ring and another section of the tool string assembly, thereby creating a blockage that can slow or stop the movement of the rotary slip ring and function of the tool string. Similarly, other debris from the wellbore or wellbore drilling process can settle, wedge, or reside in between the casing of a rotary slip ring and another section of the tool string assembly, with a similar result and challenge to operation. The linear electrical contact slip of the present disclosure can reduce the occurrence of such blockage and related slowing or stoppage due to either or both of the linear motion of the linear electrical contact slip, or the hollow structure of the linear electrical contact slip collar, which can allow some particulate matter or debris to pass through the linear electrical contact slip instead of blocking or jamming the interface between the linear electrical contact slip and other sections of a tool string.

Moreover, the manufacturability of linear electrical contact slip structures, relative to rotary slip rings known in the industry can be less complicated and more consistent in quality. In particular contrast to rotary slip rings, the linear electrical contact slip is “brushless”, not requiring individual brush structures to maintain an electrical connection as one structure rotates relative to another. The size limitations on a rotary slip ring (relating to the size limitations of a wellbore) limits the size of its brushes, and thus the amount of current that can be consistently conducted through a rotary slip ring. The elimination of such brush structures reduces the relative complexity of the linear electrical contact slip and allows for a greater degree of scalability due to the linear nature of the contact regions described herein.

The illustrative examples discussed herein are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative aspects. The following sections use directional descriptions such as “uphole,” “upward,” “downhole,” “downward,” “inward,” “outward,” etc. in relation to the illustrative aspects as they are depicted in the figures, the uphole direction being toward the surface of the well, the downhole direction being toward the toe of the well, the inward direction being toward the longitudinal axis (which can also be referred to as the “primary axis” or “centerline”) of the tool string, casing, or mandrel, and the outward direction being away from the longitudinal axis of the tool string, casing, or mandrel. Further, portions of structural elements described herein can be referred to by their general orientation when deployed, e.g. an uphole end or downhole end. Similarly, portions of structural elements described herein can be referred to by their interior (inward facing) and exterior (outward facing) surfaces. Like the illustrative aspects, the numerals and directional descriptions included in the following sections should not be used to limit the present disclosure.

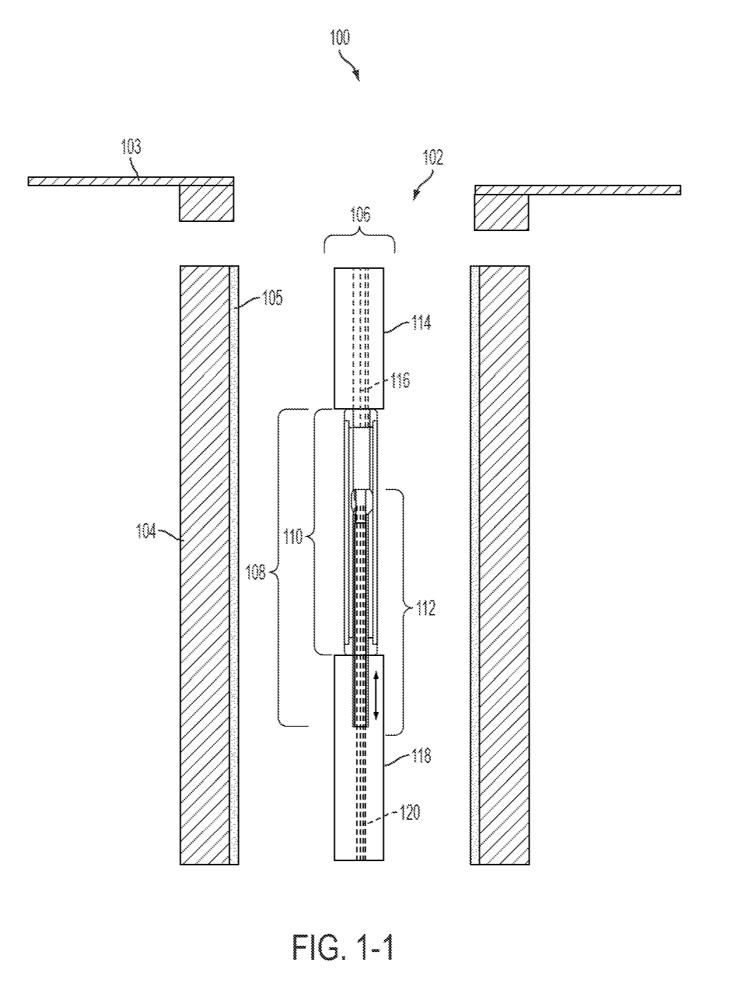

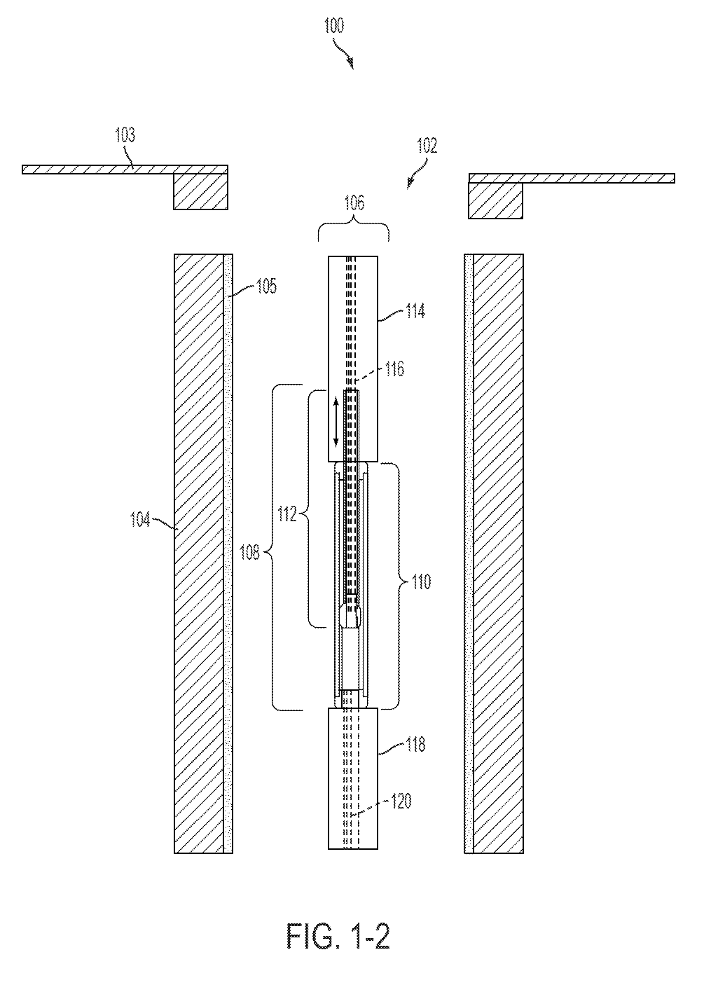

FIG. 1-1 is a schematic diagram of a well drilling system 100 having a linear electrical contact slip 108. The wellbore 102 is drilled within earth strata 104, in which a tool string 106 can be deployed. In some aspects, the sides of the wellbore 102 can be defined by a parent casing 105 supporting the earth strata 104. A section of the tool string 106 shown downhole from the surface 103 of the wellbore 102 illustrates a linear electrical contact slip 108 having a collar 110 and a piston 112, where the collar 110 is hollow and in part surrounding the piston 112.

In some aspects, the collar 110 can be oriented toward the uphole end of the wellbore 102, and can be coupled to an uphole tool string section 114. The uphole tool string section 114 can include uphole electrical leads 116 which can be electrically coupled to the linear electrical contact slip 108, and in particular aspects electrically coupled to the collar 110. The uphole electrical leads 116 can connect to other structures or sensors uphole along the tool string 106, and can further connect to a power source, a control interface, or other apparatus at the surface 103 of the wellbore 102. The piston 112 can be oriented toward the downhole end of the wellbore 102 (i.e. towards the toe of the well), and can be coupled to a downhole tool string section 118. The downhole tool string section 118 can include downhole electrical leads 120 which can be electrically coupled to the linear electrical contact slip 108, and in particular aspects electrically coupled to the piston 112. The downhole electrical leads 120 can connect to other structures or sensors downhole along the tool string 106.

When a linear electrical contact slip 108 is deployed in a wellbore 102, either the collar 110 or the piston 112 can be the stator section or the stroker section. As illustrated in FIG. 1-1, the piston 112 is the stroker section that moves with a range of motion relative to the collar 110 which is the stator section. The piston 112 is oriented and located towards the downhole direction of the wellbore 102 relative to the collar 110. The piston 112 can be actuated to extend from a position where at least a portion of the length of the piston 112 is surrounded by the collar 110 to a position where a lesser portion of the length of the piston is surrounded by the collar 110. The extent of the range of motion for the piston 112 can be between a base retracted position and a max extended position, the base retracted position and max extended position being overlapping with and within the length of the collar 110. The base retracted position is the configuration where the stator and the stroker are in a relative position of greatest overlap along their length. In FIG. 1-1, the base retracted position is where as much of the piston 112 as structurally possible is within hollow region of the collar 110, thereby establishing a minimum length of a given linear electrical contact slip 108. Electrical communication is maintained between the uphole electrical leads 116 and the downhole electrical leads 120 when the linear electrical contact slip 108 is in the base retracted position. The max extended position is the configuration where the stator and the stroker are in a relative position of least overlap along their length. In FIG. 1-1, the max extended position is where the minimum length of piston 112 possible is within hollow region of the collar 110, while still maintaining electrical communication between the uphole electrical leads 116 and the downhole electrical leads 120, thereby establishing a maximum length of a given linear electrical contact slip 108.

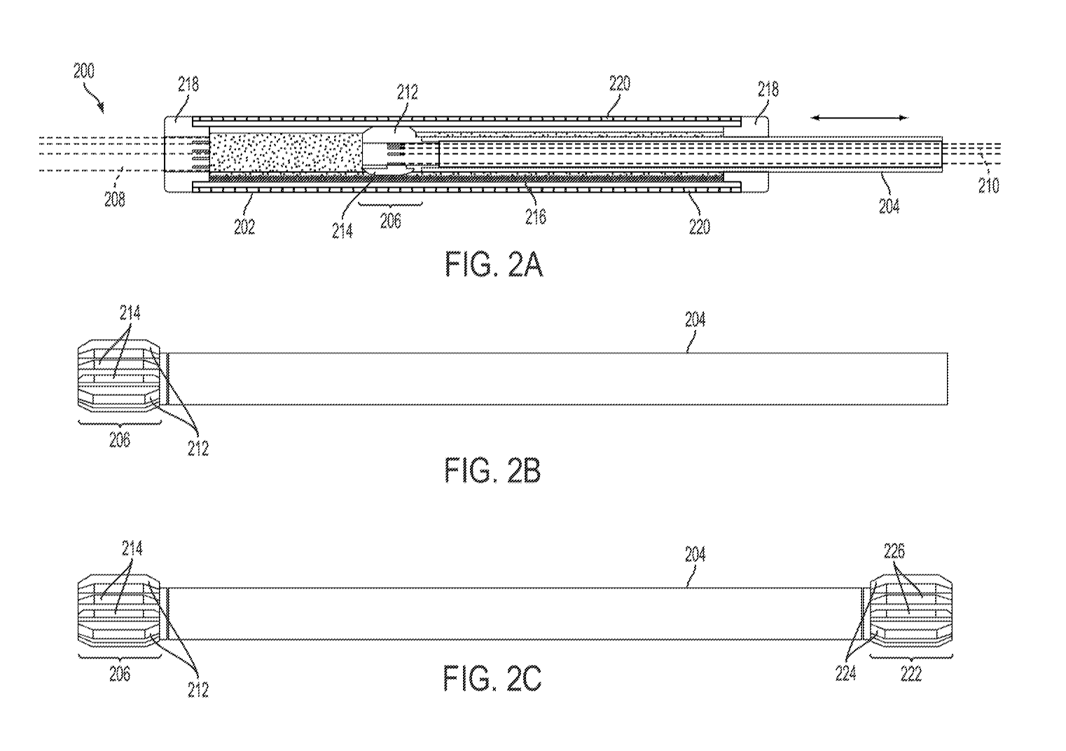

In alternative aspects, as shown in FIG. 1-2, the linear electrical contact slip 108 can be arranged such that the collar 110 is located below the piston 112 when deployed in the wellbore 102. In other words, the collar 110 can be oriented toward the downhole end of the wellbore 102, and can be coupled to a downhole tool string section 118, where the downhole electrical leads 120 of the downhole tool string section 118 electrically couple to the linear electrical contact slip 108 (and in particular aspects electrically couple to the collar 110). The downhole electrical leads 120 can further connect to other structures or sensors downhole along the tool string 106. Conversely, the piston 112 can be oriented toward the uphole end of the wellbore 102 and can be coupled to an uphole tool string section 114. The uphole tool string section 114 can include uphole electrical leads 116 which can be electrically coupled to the linear electrical contact slip 108 (and in particular aspects electrically coupled to the piston 112). The uphole electrical leads 116 can connect to other structures or sensors uphole along the tool string 106, and can further connect to a power source, a control interface, or other apparatus at the surface 103 of the wellbore 102.

It is appreciated that, regardless of the orientation of the linear electrical contact slip 108, either the uphole end or downhole end of the of the linear electrical contact slip 108 can be considered a first end or a second end when referring to components of the linear electrical contact slip 108 such as, for example, the electrical leads, which may be referred to as a first set of electrical leads and a second set of electrical leads. Similarly, it is appreciated that regardless of whether a piston 112 structure or a collar 110 structure is a stroker section, the movement and range of motion of a stroker section between a base retracted position and a max extended position is overlapping with and within the length of a counterpart stator section.

FIG. 2A is a side-view cross-sectional schematic diagram of a linear electrical contact slip 200 having an exterior collar structure 202 and an interior piston structure 204. As shown in FIG. 2A, the collar structure 202 is the stator section and the piston structure 204 is the stroker section, though in alternative embodiments these roles can be reversed. The piston structure 204 can include an electrical contact head 206 defining the end of the piston structure 204 positioned within the collar structure 202. During the linear motion of the stroker section, the piston structure 204 moves within the collar structure 202 with the one or more key projections 212, particularly located in the electrical contact head 206 region, sliding along one or more corresponding keyways within the collar structure 202. As the piston structure 204 moves, one or more piston electrical contact regions 214, also located in the electrical contact head 206 region, exposed and facing outward on the surface of the piston structure 204 are in electrical contact with one or more corresponding collar electrical contact regions 216 exposed and facing inward on the interior surface of the collar structure 202. In particular, the collar electrical contact regions 216 can be canted coil springs. The positive contact between the piston electrical contact regions 214 and the collar electrical contact regions 216 thereby allows for electrical power or signals to pass through from a first set of electrical leads 208 coupled to the collar structure 202, through the collar electrical contact regions 216 (and optionally any additional conductive elements connecting the first set of electrical leads 208 to the collar electrical contact regions 216), to the piston electrical contact regions 214, and to a second set of electrical leads 210 coupled to the piston structure 204.

The structure of the piston electrical contact regions 214 can have a lead angle along the longitudinal axis of each piston electrical contact region 214, at both ends of the stroker electrical contact region 214. Where the collar electrical contact regions 216 are canted coils, the lead angle of the piston electrical contact region 214 structure can ensure the gradual deformation of the canted coil springs as the piston structure 204 moves in either linear direction (i.e. uphole or downhole) along the length of the linear electrical contact slip 200. The degree of deflection on a canted coil spring helps to ensure positive electrical contact as well as to lower any friction created between the piston electrical contact regions 214 and the collar electrical contact regions 216 during the linear motion.

In some aspects, the collar structure 202 can have end coupling regions 218 on either or both ends of the collar structure 202 that allow the collar structure 202 to couple with uphole and downhole tool string sections. In such aspects, the end coupling regions 218 can be threaded to mechanically couple with complementary uphole and downhole tool string sections. In further aspects, the collar structure 202 can include exterior casing 220 that can provide additional protection for the first set of electrical leads 208, collar electrical contact regions 216, and overall piston structure 204 from the wellbore environment.

FIG. 2B is a side-view illustration of a piston structure 204 as shown in FIG. 2A, having an electrical contact head 206 on one end of the piston structure 204. The electrical contact head 206 includes both a plurality of key projections 212 and a plurality of piston electrical contact regions 214. The electrical contact head 206 can be constructed to have an arrangement of key projections 212 that correspond to keyways in a matching collar structure, where the key projections 212 can be shaped to smoothly interface with the collar structure to allow for continuous motion without incremental steps causing pauses in motion as the piston structure moves within the collar structure.

FIG. 2C is an illustration of a piston structure 204 as shown in FIG. 2A, having a first electrical contact head 206 and further having a second electrical contact head 222 positioned on an opposing end of the piston structure 204 from the first electrical contact head 206. The second electrical contact head has a second plurality of key projections 224 and a second plurality of electrical contact regions 226 that are analogous to the plurality of key projections 212 and a plurality of piston electrical contact regions 214, respectively, on the first electrical contact head 206. The electrical contact heads 206, 222 can be constructed to have an arrangement of key projections 212, 224 that correspond to keyways in a matching collar structure, where the key projections 212, 224 can be shaped to smoothly interface with the collar structure to allow for continuous motion without incremental steps causing pauses in motion as the piston structure 204 moves within the collar structure. In embodiments where the piston structure 204 has electrical contact heads 206, 222 on each end, each electrical contact head 206, 222 can couple and interface with electrical leads on either side of the piston structure 204. In some aspects, the piston structure 204 can concurrently couple with a first collar structure surrounding a first electrical contact head 206 and a second collar structure surrounding a second electrical contact head 222. In other aspects, the first electrical contact head 206 can couple with a corresponding collar structure and the second electrical contact head 222 can couple with an additional electrical contact structure on a tool string.

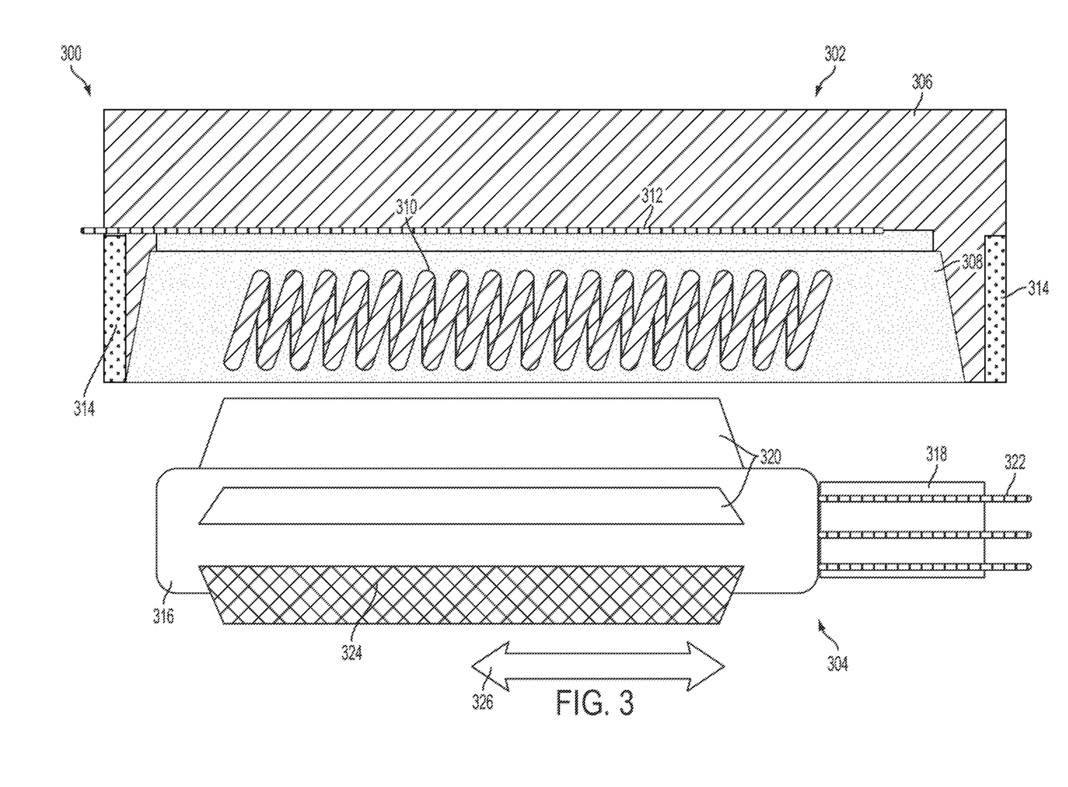

FIG. 3 is a schematic illustration 300 of an electrical contact head 316 and electrical contact elements 320 in relation to a conductive canted coil 310 mounted within a collar structure 302. In part, FIG. 3 shows in further detail an arrangement of electrical contact elements within a collar structure 302 of the present disclosure. The collar body 306 is a hollow structure, shaped to have a cavity facing inward toward a piston body 304. The cavity of the collar body 306 is lined with a contact slip housing 308, which is made of an electrically conductive material. The contact slip housing 308 is configured to hold, constrain, and be in electrical communication with a collar electrical contact region, which as illustrated is a canted coil 310. In some aspects, the canted coil 310 can be plated with a conductive metal, which in particular aspects can be a metal such as gold. To minimize or reduce any undesired abrasive or capacitive effects, both the contact slip housing 308 and the canted coil 310 should be made of, or plated with, the same conductive metal. The contact slip housing 308 is also in electrical communication with a first set of electrical leads 312, where the first set of electrical leads 312 can further be in communication with additional instrumentation or power sources either uphole or downhole from the collar structure 302. The structural and spring characteristics of canted coil 310 allow the canted coil 310 to reside securely within the cavity defined by contact slip housing 308. In some aspects, at both ends of the contact slip housing 308, contact clip retainers 314 can be located and structured to constrain the canted coil 310 from slipping or otherwise coming out of the contact slip housing 308. In other aspects, at least one of the contact clip retainers 314 can function to electrically connect the first set of electrical leads 312 with the contact slip housing 308. In further aspects, the contact clip retainers 314 can function as a bushing support to the linear motion 326 of the stroker section (which as illustrated is the piston body 304), guiding the piston body 304 and reducing friction as the piston body passes alongside the collar body 306.

Similarly, FIG. 3 shows, in part, further detail of an arrangement of electrical contact elements of a piston body 304 of the present disclosure. The piston body 304 can include a piston head 316 and a piston shaft 318, where the piston head 316 can be configured to have a diameter approximately the same as or slightly greater than the piston shaft 318. The piston head 316 includes at least one piston electrical contact 320, which can be described as a fin or projection, and that electrically couple with a second set of electrical leads 322 that extend through the piston shaft 318. The second set of electrical leads 322 can further be in communication with additional instrumentation or power sources either uphole or downhole from the piston body 304. Each of the one or more piston electrical contacts 320 can match with a canted coil 310 held within in the collar body 306, and thereby establish an electrical connection from the first set of electrical leads 312, to a contact slip housing 308, through a canted coil 310, to a piston electrical contact 320, and to the second set of electrical leads 322. The electrical connection between the elements of the collar structure 302 and the piston body 304 can be maintained as the stroker section moves with linear motion 326.

The piston head 316 can further include at least one key projection 324 which is configured to match with and fill in a keyway (not shown) in the collar body 306. The one or more key projections 324 of the piston head 316, due to being maintained in a specific orientation within the keyways of the collar body 306, thereby prevent rotational motion of either the stroker section or the stator section relative to each other, further operating to maintain the electrical connection between the elements of the collar structure 302 and the piston body 304 as the stroker section moves with linear motion 326.

The interface of one or more piston electrical contacts 320 with one or more canted coils 310 reflects the lead angle along the longitudinal axis of each piston electrical contact 320 which can provide for gradual deformation of the canted coil 310 springs as the piston body 304 moves in either linear direction. The degree of deflection on a canted coil 310 spring in part allows for a contact force that helps to ensure positive electrical contact between the piston electrical contacts 320 and the canted coils 310 during the linear motion. In some aspects, the electrical contact between the piston electrical contacts 320 and the canted coils 310 can allow for a stable and consistent passage of current of up to thirty Amperes (30 A).

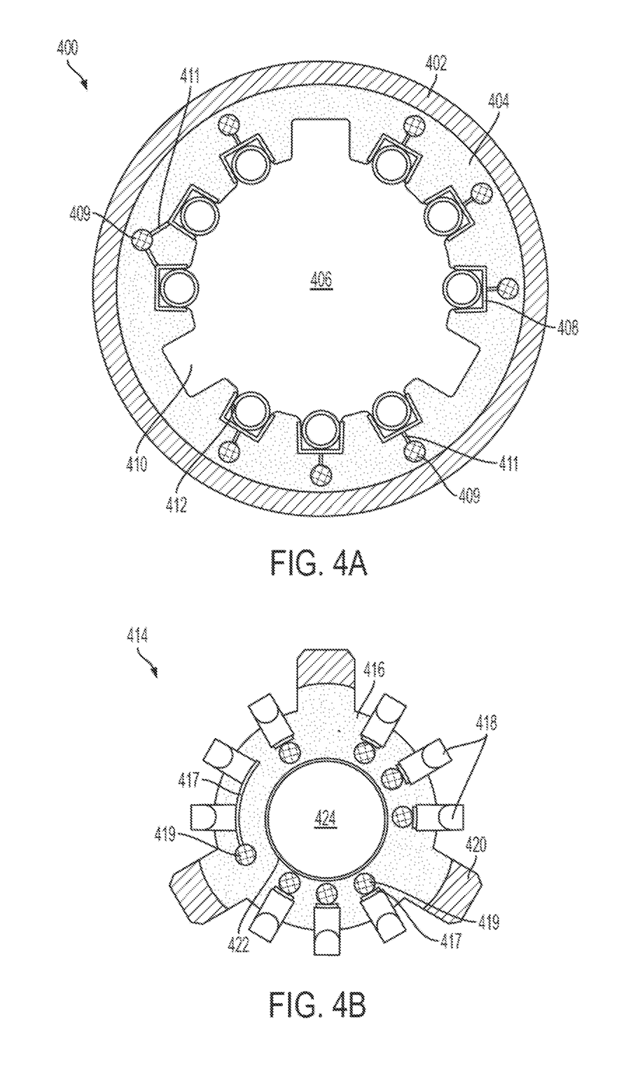

FIG. 4A is an end-view cross-sectional schematic diagram of a collar structure 400 of a linear electrical contact slip configured to receive three groupings of electrical contacts, where each grouping includes three electrical contacts. The collar structure 400 has an outer casing 402, which can be a metal casing having sufficient strength characteristics to withstand a wellbore environment. In some aspects, the casing can be a corrosion-resistant metal, such as various types of stainless steel. The collar structure 400 can contain several components within the collar body 404, including contact slip housings 408 with metal casings, contact slip retainers (not shown), and canted coil 412 springs. The collar body 404 can be formed of an engineering plastic that has strong electrical insulator properties and chemical resistance and can further withstand high temperatures with minimum distortion as found in a wellbore environment. Such engineering plastics can include, but are not limited to, polyether ether ketone (PEEK), polyaryletherketone (PAEK), glass-filled polyamide 6/6 (PA66), and other such thermoplastic polymers or electrical insulator materials that can withstand the operating temperatures within a wellbore environment. The collar body 404 can be further molded or cut to have keyways 410 configured to receive key projections from a corresponding piston body. In some aspects, the canted coil 412 springs are each retained inside the contact slip housings 408, where each contact slip housing 408 is over-molded or plated with gold plate metal. The contact slip housing 408 can be over-molded or plated with conductive metal during molding of the collar body 404, or extruded onto the interior surface of the contact slip housing 408 regions after fabricating the collar body 404. The canted coil 412 springs are installed and seated inside the pre-molded grooves in the collar body 404 after the contact slip housing 408 are over-molded or plated with gold plate metal.

The collar body 404 can have collar electrical leads 409 embedded within the material of the collar body, with embedded collar wiring 411 electrically connecting one or more of the contact slip housings 408 with one or more of the collar electrical leads 409. In some aspects, each contact slip housing 408 can be coupled through embedded collar wiring 411 to a single collar electrical lead 409. In other aspects, two or more contact slip housings 408 can be coupled through embedded collar wiring 411 to a single collar electrical lead 409. The distribution of electrical connections between the contact slip housings 408 and collar electrical leads 409 can be arranged to increase or otherwise control the conductivity of the electrical connection formed by the electrical connections between the contact slip housings 408 and collar electrical leads 409. An increase of conductivity between the contact slip housings 408 and collar electrical leads 409 can provide for relatively high power draw applications. Depending on the orientation and arrangement of a linear electrical contact slip, the collar electrical leads 409 can be a part of either uphole electrical leads or downhole electrical leads. In further aspects, the embedded collar wiring 411 can be an electrically conductive element such as a filament, an electrical bridge, an electrical tangency, or other metallic connection between a contact slip housing 408 and a collar electrical lead 409.

The collar structure 400 is further formed to have a hollow space, referred to as a collar core 406, in which a piston structure can reside and move with a linear motion. Due to the designed architecture of the collar core 406 in the collar structure 400, electrically non-conductive hydraulic oil can pass through the collar structure 400 (and around any piston structure) in uphole and downhole directions. Therefore, the linear electrical contact slip of the present disclosure does not experience any pressure differential between the uphole end and downhole end of the collar structure 400. Similarly, the linear electrical contact slip of the present disclosure does not experience any pressure differential between the collar core 406 of the collar structure 400 and the region of a wellbore surrounding the collar structure 400. Accordingly, the linear electrical contact slip of the present disclosure can withstand the high pressures experienced in oil-filled wellbore applications without the need to actively control the pressure of the electrical contact regions, and without concern of structural collapse or failure of the linear electrical contact slip due to high pressures.

FIG. 4B is an end-view cross-sectional schematic diagram of a piston structure 414 of a linear electrical contact slip configured to have three groupings of electrical contacts, where each grouping includes three electrical contacts. Specifically illustrated in cross-section is a piston head 416, which can be made of an engineering plastic similar to the material used to form the collar body 404, having strong electrical insulator properties and chemical resistance and can further withstand high temperatures with minimum distortion as found in a wellbore environment. The piston head 416 can contain components extending outward from the centerline of the piston head 416 (and by extension, from the longitudinal axis of a connected piston shaft) including one or more piston electrical contacts 418 and one or more key projections 420. The one or more piston electrical contacts 418 can be formed by over-molding a projected section of the piston head 416 with a conductive metal, or by inserting and attaching separate electrically conductive elements to the surface of the piston head 416. In some aspects, the formation of the one or more piston electrical contacts 418 by over-molding a portion of the piston head can have a stronger bond than attaching separate electrically conductive elements to the surface of the piston head 416, and the method of forming the piston structure 414 can be selected accordingly depending on design requirements, or the need to replace any individual piston electrical contact 418.

The piston structure 414 can further electrically couple the piston electrical contacts 418 to piston electrical leads 419 via embedded piston wiring 417 embedded within the piston structure 414. In some aspects, each piston electrical contact 418 can be coupled through embedded piston wiring 417 to a single piston electrical lead 419. In other aspects, two or more piston electrical contacts 418 can be coupled through embedded piston wiring 417 to a piston electrical lead 419. In further aspects, the piston electrical leads 419 can further connect to the a conductive metal housing 422 surrounding the interior surface of the piston structure 414, and which can define a hollow space, referred to as a piston core 424, of the piston head 416 and connected piston shaft. Either or both of the piston electrical leads 419 and conductive metal housing 422 can extend along the piston shaft to a terminus at an opposing end of the piston. Depending on the orientation and arrangement of a linear electrical contact slip, the piston electrical leads 419 can be a part of either uphole electrical leads or downhole electrical leads. In further aspects, the embedded piston wiring 417 can be an electrically conductive element such as a filament, an electrical bridge, an electrical tangency, or other metallic connection between a piston electrical contact 418 and a piston electrical lead 419.

Considered in combination, FIG. 4A and FIG. 4B illustrate the interaction and coupling of both the key projections 420 with the keyways 410 and the piston electrical contacts 418 with the canted coils 412. In some aspects, the piston structure 414 can fit within the collar core 406 of the collar structure 400, such that the piston structure 414 and piston head 416 can move linearly along the longitudinal axis of the collar structure 400. The keyways 410 of the collar structure 404 are in part an extension of the collar core 406, providing passages for key projections 420 on the piston structure 414. The arrangement of the key projections 420 and the keyways 410 allow for linear motion along the longitudinal axes of the collar structure 400 and piston structure 414, and further operate to prevent rotation of the piston structure 414 within the collar core 406 of the collar structure 400, or vice versa. In some aspects, either or both of the key projections 420 and the keyways 410 can be considered antirotational features. Rotation of either the collar structure 400 or the piston structure 414 could result in an electrical short circuit or a loss of electrical communication between electrically conductive elements of the collar structure 400 and the piston structure 414. As illustrated in FIG. 4A and FIG. 4B, the piston structure 414 can have three key projections 420 that extend into three corresponding keyways 410 molded into the collar body 404 of the collar structure 400.

As further illustrated in FIG. 4A and FIG. 4B, the piston structure 414 can have three groupings of piston electrical contacts 418, where each grouping has three individual piston electrical contacts 418 (resulting in a total of nine electrical couplings between the piston structure 414 and collar structure 400). Each piston electrical contact 418 has a corresponding canted coil 412 secured within contact slips housings 408 of the collar structure 400, forming individual pairings of piston electrical contacts 418 with canted coils 412. Accordingly, as either a piston structure 414 or a collar structure 400 moves linearly with respect to the other, the length of each piston electrical contact 418 remains in electrical communication with a corresponding canted coil 412, allowing for the conduction of electricity as either of the piston structure 414 or collar structure 400 moves. While stationary or in motion, the connection between the piston electrical contacts 418 and canted coils 412 can provide for stable and consistent passage of current of up to thirty Amperes (30 A). The amount of electricity conducted can be distributed across the nine electrical couplings illustrated. If any one or more of the electrical couplings disconnects, shorts, or fails, the remaining electrical couplings can provide for the continued transmission of the same amount of current prior to the one or more of the electrical coupling failures.

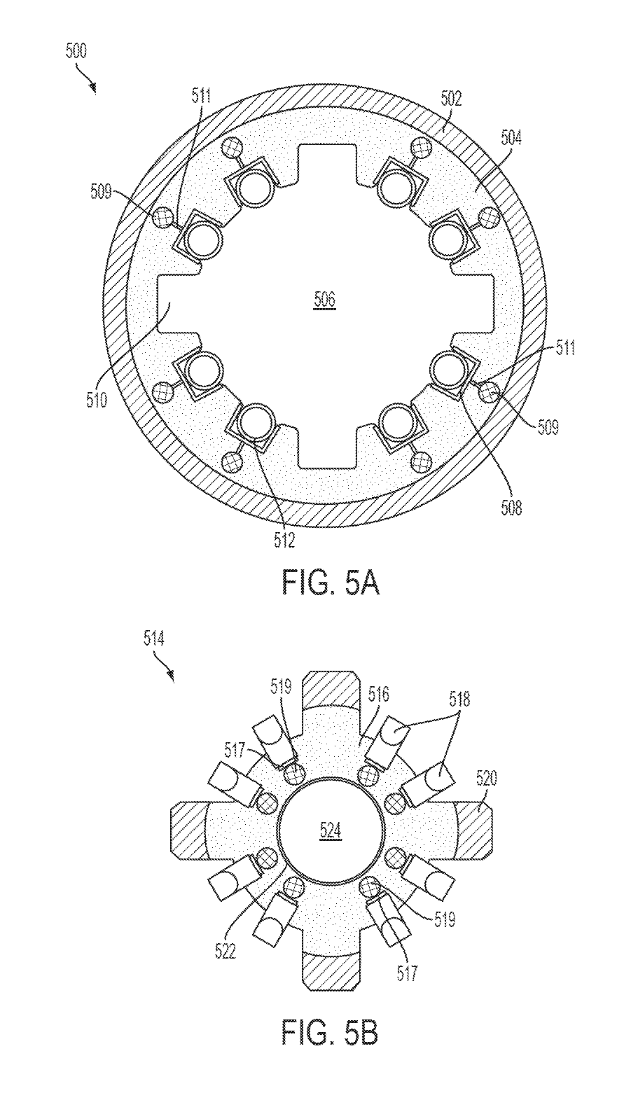

FIG. 5A is an end-view cross-sectional schematic diagram of a collar structure 500 of a linear electrical contact slip configured to receive four groupings of electrical contacts, where each grouping includes two electrical contacts. The collar structure 500 has an outer casing 502, which can be a metal casing having sufficient strength characteristics to withstand a wellbore environment. In some aspects, the casing can be a corrosion-resistant metal, such as various types of stainless steel. The collar structure 500 can contain several components within the collar body 504, including contact slip housings with metal casings 508, contact slip retainers (not shown), and canted coil 512 springs. The collar body 504 can be formed of an engineering plastic that has strong electrical insulator properties and chemical resistance and can further withstand high temperatures with minimum distortion as found in a wellbore environment. Such engineering plastics can include, but are not limited to, PEEK, PAEK, PA66, and other such thermoplastic polymers or electrical insulator materials that can withstand the operating temperatures within a wellbore environment. The collar body 504 can be further molded to have keyways 510 configured to receive key projections from a corresponding piston body. In some aspects, the canted coil 512 springs are each retained inside the contact slips housings 508, where each contact slips housing 508 is over-molded or plated with gold plate metal. The contact slips housing 508 can be over-molded or plated with conductive metal during molding of the collar body 504, or extruded onto the interior surface of the contact slips housing 508 regions after fabricating the collar body 504. The canted coil 512 springs are installed and seated inside the pre-molded grooves in the collar body 504 after the contact slips housing 508 are over-molded or plated with gold plate metal.

The collar body 504 can have collar electrical leads 509 embedded within the material of the collar body, with embedded collar wiring 511 electrically connecting one or more of the contact slip housings 508 with one or more of the collar electrical leads 509. In some aspects, each contact slip housing 508 can be coupled through embedded collar wiring 511 to a single collar electrical lead 509. In other aspects, two or more contact slip housings 508 can be coupled through embedded collar wiring 511 to a single collar electrical lead 509. The distribution of electrical connections between the contact slip housings 508 and collar electrical leads 509 can be arranged to increase or otherwise control the conductivity of the electrical connection formed by the electrical connections between the contact slip housings 508 and collar electrical leads 509. An increase of conductivity between the contact slip housings 508 and collar electrical leads 509 can provide for relatively high power draw applications. Depending on the orientation and arrangement of a linear electrical contact slip, the collar electrical leads 509 can be a part of either uphole electrical leads or downhole electrical leads. In further aspects, the embedded collar wiring 511 can be an electrically conductive element such as a filament, an electrical bridge, an electrical tangency, or other metallic connection between a contact slip housing 508 and a collar electrical lead 409.

The collar structure 500 is further formed to have a hollow space, referred to as a collar core 506, in which a piston structure can reside and move with a linear motion. Due to the designed architecture of the collar core 506 in the collar structure 500, electrically non-conductive hydraulic oil can pass through the collar structure 500 (and around any piston structure) in uphole and downhole directions. Therefore, the linear electrical contact slip of the present disclosure does not experience any pressure differential between the uphole end and downhole end of the collar structure 500. Similarly, the linear electrical contact slip of the present disclosure does not experience any pressure differential between the collar core 506 of the collar structure 500 and the region of a wellbore surrounding the collar structure 500. Accordingly, the linear electrical contact slip of the present disclosure can withstand the high pressures experienced in oil-filled wellbore applications without the need to actively control the pressure of the electrical contact regions, and without concern of structural collapse or failure of the linear electrical contact slip due to high pressures.

FIG. 5B is an end-view cross-sectional schematic diagram of a piston structure 514 of a linear electrical contact slip configured to have four groupings of electrical contacts, where each grouping includes two electrical contacts. Specifically illustrated in cross-section is a piston head 516, which can be made of an engineering plastic similar to the material used to form the collar body 504, having strong electrical insulator properties and chemical resistance and can further withstand high temperatures with minimum distortion as found in a wellbore environment. The piston head 516 can contain components extending outward from the centerline of the piston head 516 (and by extension, from the longitudinal axis of a connected piston shaft) including one or more piston electrical contacts 518 and one or more key projections 520. The one or more piston electrical contacts 518 can be formed by over-molding a projected section of the piston head 516 with a conductive metal, or by inserting and attaching separate electrically conductive elements to the surface of the piston head 516. In some aspects, the formation of the one or more piston electrical contacts 518 by over-molding a portion of the piston head can have a stronger bond than attaching separate electrically conductive elements to the surface of the piston head 516, and the method of forming the piston structure 514 can be selected accordingly depending on design requirements, or the need to replace any individual piston electrical contact 518.

The piston structure 514 can further electrically couple the piston electrical contacts 518 to piston electrical leads 519 via embedded piston wiring 517 embedded within the piston structure 514. In some aspects, each piston electrical contact 518 can be coupled through embedded piston wiring 517 to a single piston electrical lead 519. In other aspects, two or more piston electrical contacts 518 can be coupled through embedded piston wiring 517 to a piston electrical lead 519. In further aspects, the piston electrical leads 519 can further connect to the a conductive metal housing 522 surrounding the interior surface of the piston structure 514, and which can define a hollow space, referred to as a piston core 524, of the piston head 516 and connected piston shaft. Either or both of the piston electrical leads 519 and conductive metal housing 522 can extend along the piston shaft to a terminus at an opposing end of the piston. Depending on the orientation and arrangement of a linear electrical contact slip, the piston electrical leads 519 can be a part of either uphole electrical leads or downhole electrical leads. In further aspects, the embedded piston wiring 517 can be an electrically conductive element such as a filament, an electrical bridge, an electrical tangency, or other metallic connection between a piston electrical contact 518 and a piston electrical lead 519.

Considered in combination, FIG. 5A and FIG. 5B illustrate the interaction and coupling of both the key projections 520 with the keyways 510 and the piston electrical contacts 518 with the canted coils 512. In some aspects, the piston structure 514 can fit within the collar core 506 of the collar structure 500, such that the piston structure 514 and piston head 516 can move linearly along the longitudinal axis of the collar structure 500. The keyways 510 of the collar structure 504 are in part an extension of the collar core 506, providing passages for key projections 520 on the piston structure 514. The arrangement of the key projections 520 and the keyways 510 allow for linear motion along the longitudinal axes of the collar structure 500 and piston structure 514, and further operate to prevent rotation of the piston structure 514 within the collar core 506 of the collar structure 500, or vice versa. In some aspects, either or both of the key projections 520 and the keyways 510 can be considered antirotational features. Rotation of either the collar structure 500 or the piston structure 514 could result in an electrical short circuit or a loss of electrical communication between electrically conductive elements of the collar structure 500 and the piston structure 514. As illustrated in FIG. 5A and FIG. 5B, the piston structure 514 can have four key projections 520 that extend into four corresponding keyways 510 molded into the collar body 504 of the collar structure 500.

As further illustrated in FIG. 5A and FIG. 5B, the piston structure 514 can have four groupings of piston electrical contacts 518, where each grouping has two individual piston electrical contacts 518 (resulting in a total of eight electrical couplings between the piston structure 514 and collar structure 500). Each piston electrical contact 518 has a corresponding canted coil 512 secured within contact slips housings 508 of the collar structure 500, forming individual pairings of piston electrical contacts 518 with canted coils 512. Accordingly, as either a piston structure 514 or a collar structure 500 moves linearly with respect to the other, the length of each piston electrical contact 518 remains in electrical communication with a corresponding canted coil 512, allowing for the conduction of electricity as either of the piston structure 514 or collar structure 500 moves. While stationary or in motion, the connection between the piston electrical contacts 518 and canted coils 512 can provide for stable and consistent passage of current of up to thirty Amperes (30 A). The amount of electricity conducted can be distributed across the eight electrical couplings illustrated. If any one or more of the electrical couplings disconnects, shorts, or fails, the remaining electrical couplings can provide for the continued transmission of the same amount of current prior to the one or more of the electrical coupling failures.

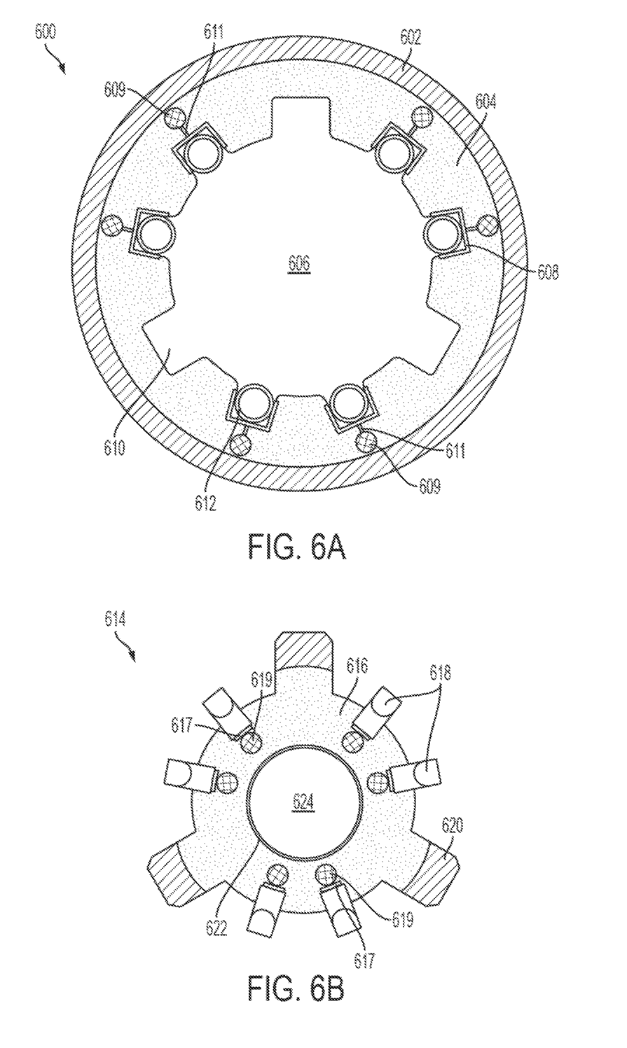

FIG. 6A is an end-view cross-sectional schematic diagram of a collar structure 600 of a linear electrical contact slip configured to receive three groupings of electrical contacts, where each grouping includes two electrical contacts. The collar structure 600 has an outer casing 602, which can be a metal casing having sufficient strength characteristics to withstand a wellbore environment. In some aspects, the casing can be a corrosion-resistant metal, such as various types of stainless steel. The collar structure 600 can contain several components within the collar body 604, including contact slip housings with metal casings 508, contact slip retainers (not shown), and canted coil 612 springs. The collar body 604 can be formed of an engineering plastic that has strong electrical insulator properties and chemical resistance and can further withstand high temperatures with minimum distortion as found in a wellbore environment. Such engineering plastics can include, but are not limited to, PEEK, PAEK, PA66, and other such thermoplastic polymers or electrical insulator materials that can withstand the operating temperatures within a wellbore environment. The collar body 604 can be further molded to have keyways 610 configured to receive key projections from a corresponding piston body. In some aspects, the canted coil 612 springs are each retained inside the contact slips housings 608, where each contact slips housing 608 is over-molded or plated with gold plate metal. The contact slips housing 608 can be over-molded or plated with conductive metal during molding of the collar body 604, or extruded onto the interior surface of the contact slips housing 608 regions after fabricating the collar body 604. The canted coil 612 springs are installed and seated inside the pre-molded grooves in the collar body 604 after the contact slips housing 608 are over-molded or plated with gold plate metal.

The collar body 604 can have collar electrical leads 609 embedded within the material of the collar body, with embedded collar wiring 611 electrically connecting one or more of the contact slip housings 608 with one or more of the collar electrical leads 609. In some aspects, each contact slip housing 608 can be coupled through embedded collar wiring 611 to a single collar electrical lead 609. In other aspects, two or more contact slip housings 608 can be coupled through embedded collar wiring 611 to a single collar electrical lead 609. The distribution of electrical connections between the contact slip housings 608 and collar electrical leads 609 can be arranged to increase or otherwise control the conductivity of the electrical connection formed by the electrical connections between the contact slip housings 608 and collar electrical leads 609. An increase of conductivity between the contact slip housings 608 and collar electrical leads 609 can provide for relatively high power draw applications. Depending on the orientation and arrangement of a linear electrical contact slip, the collar electrical leads 609 can be a part of either uphole electrical leads or downhole electrical leads. In further aspects, the embedded collar wiring 611 can be an electrically conductive element such as a filament, an electrical bridge, an electrical tangency, or other metallic connection between a contact slip housing 608 and a collar electrical lead 609.

The collar structure 600 is further formed to have a hollow space, referred to as a collar core 606, in which a piston structure can reside and move with a linear motion. Due to the designed architecture of the collar core 606 in the collar structure 600, electrically non-conductive hydraulic oil can pass through the collar structure 600 (and around any piston structure) in uphole and downhole directions. Therefore, the linear electrical contact slip of the present disclosure does not experience any pressure differential between the uphole end and downhole end of the collar structure 600. Similarly, the linear electrical contact slip of the present disclosure does not experience any pressure differential between the collar core 606 of the collar structure 600 and the region of a wellbore surrounding the collar structure 600. Accordingly, the linear electrical contact slip of the present disclosure can withstand the high pressures experienced in oil-filled wellbore applications without the need to actively control the pressure of the electrical contact regions, and without concern of structural collapse or failure of the linear electrical contact slip due to high pressures.

FIG. 6B is an end-view cross-sectional schematic diagram of a piston structure 614 of a linear electrical contact slip configured to have three groupings of electrical contacts, where each grouping includes two electrical contacts. Specifically illustrated in cross-section is a piston head 616, which can be made of an engineering plastic similar to the material used to form the collar body 604, having strong electrical insulator properties and chemical resistance and can further withstand high temperatures with minimum distortion as found in a wellbore environment. The piston head 616 can contain components extending outward from the centerline of the piston head 616 (and by extension, from the longitudinal axis of a connected piston shaft) including one or more piston electrical contacts 618 and one or more key projections 620. The one or more piston electrical contacts 618 can be formed by over-molding a projected section of the piston head 616 with a conductive metal, or by inserting and attaching separate electrically conductive elements to the surface of the piston head 616. In some aspects, the formation of the one or more piston electrical contacts 618 by over-molding a portion of the piston head can have a stronger bond than attaching separate electrically conductive elements to the surface of the piston head 616, and the method of forming the piston structure 614 can be selected accordingly depending on design requirements, or the need to replace any individual piston electrical contact 618.

The piston structure 614 can further electrically couple the piston electrical contacts 618 to piston electrical leads 619 via embedded piston wiring 617 embedded within the piston structure 614. In some aspects, each piston electrical contact 618 can be coupled through embedded piston wiring 617 to a single piston electrical lead 619. In other aspects, two or more piston electrical contacts 618 can be coupled through embedded piston wiring 617 to a piston electrical lead 619. In further aspects, the piston electrical leads 619 can further connect to the a conductive metal housing 622 surrounding the interior surface of the piston structure 614, and which can define a hollow space, referred to as a piston core 624, of the piston head 616 and connected piston shaft. Either or both of the piston electrical leads 619 and conductive metal housing 622 can extend along the piston shaft to a terminus at an opposing end of the piston. Depending on the orientation and arrangement of a linear electrical contact slip, the piston electrical leads 619 can be a part of either uphole electrical leads or downhole electrical leads. In further aspects, the embedded piston wiring 617 can be an electrically conductive element such as a filament, an electrical bridge, an electrical tangency, or other metallic connection between a piston electrical contact 618 and a piston electrical lead 619.

Considered in combination, FIG. 6A and FIG. 6B illustrate the interaction and coupling of both the key projections 620 with the keyways 610 and the piston electrical contacts 618 with the canted coils 612. In some aspects, the piston structure 614 can fit within the collar core 606 of the collar structure 600, such that the piston structure 614 and piston head 616 can move linearly along the longitudinal axis of the collar structure 600. The keyways 610 of the collar structure 604 are in part an extension of the collar core 606, providing passages for key projections 620 on the piston structure 614. The arrangement of the key projections 620 and the keyways 610 allow for linear motion along the longitudinal axes of the collar structure 600 and piston structure 614, and further operate to prevent rotation of the piston structure 614 within the collar core 606 of the collar structure 600, or vice versa. In some aspects, either or both of the key projections 620 and the keyways 610 can be considered antirotational features. Rotation of either the collar structure 600 or the piston structure 614 could result in an electrical short circuit or a loss of electrical communication between electrically conductive elements of the collar structure 600 and the piston structure 614. As illustrated in FIG. 6A and FIG. 6B, the piston structure 614 can have three key projections 620 that extend into three corresponding keyways 610 molded into the collar body 604 of the collar structure 600.

As further illustrated in FIG. 6A and FIG. 6B, the piston structure 614 can have three groupings of piston electrical contacts 618, where each grouping has two individual piston electrical contacts 618 (resulting in a total of six electrical couplings between the piston structure 614 and collar structure 600). Each piston electrical contact 618 has a corresponding canted coil 612 secured within contact slips housings 608 of the collar structure 600, forming individual pairings of piston electrical contacts 618 with canted coils 612. Accordingly, as either a piston structure 614 or a collar structure 600 moves linearly with respect to the other, the length of each piston electrical contact 618 remains in electrical communication with a corresponding canted coil 612, allowing for the conduction of electricity as either of the piston structure 614 or collar structure 600 moves. While stationary or in motion, the connection between the piston electrical contacts 618 and canted coils 612 can provide for stable and consistent passage of current of up to thirty Amperes (30 A). The amount of electricity conducted can be distributed across the six electrical couplings illustrated. If any one or more of the electrical couplings disconnects, shorts, or fails, the remaining electrical couplings can provide for the continued transmission of the same amount of current prior to the one or more of the electrical coupling failures.

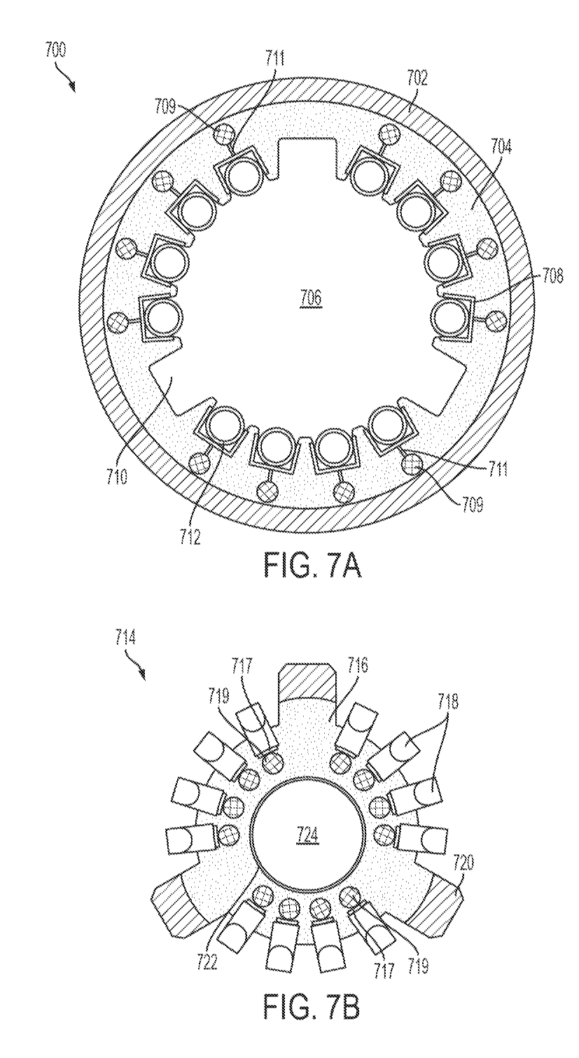

FIG. 7A is an end-view cross-sectional schematic diagram of a collar structure 700 of a linear electrical contact slip configured to receive three groupings of electrical contacts, where each grouping includes four electrical contacts. The collar structure 700 has an outer casing 702, which can be a metal casing having sufficient strength characteristics to withstand a wellbore environment. In some aspects, the casing can be a corrosion-resistant metal, such as various types of stainless steel. The collar structure 700 can contain several components within the collar body 704, including contact slip housings with metal casings 708, contact slip retainers (not shown), and canted coil 712 springs. The collar body 704 can be formed of an engineering plastic that has strong electrical insulator properties and chemical resistance and can further withstand high temperatures with minimum distortion as found in a wellbore environment. Such engineering plastics can include, but are not limited to, PEEK, PAEK, PA66, and other such thermoplastic polymers or electrical insulator materials that can withstand the operating temperatures within a wellbore environment. The collar body 704 can be further molded to have keyways 710 configured to receive key projections from a corresponding piston body. In some aspects, the canted coil 712 springs are each retained inside the contact slips housings 708, where each contact slips housing 708 is over-molded or plated with gold plate metal. The contact slips housing 708 can be over-molded or plated with conductive metal during molding of the collar body 704, or extruded onto the interior surface of the contact slips housing 708 regions after fabricating the collar body 704. The canted coil 712 springs are installed and seated inside the pre-molded grooves in the collar body 704 after the contact slips housing 708 are over-molded or plated with gold plate metal.

The collar body 704 can have collar electrical leads 709 embedded within the material of the collar body, with embedded collar wiring 711 electrically connecting one or more of the contact slip housings 708 with one or more of the collar electrical leads 709. In some aspects, each contact slip housing 708 can be coupled through embedded collar wiring 711 to a single collar electrical lead 709. In other aspects, two or more contact slip housings 708 can be coupled through embedded collar wiring 711 to a single collar electrical lead 709. The distribution of electrical connections between the contact slip housings 708 and collar electrical leads 709 can be arranged to increase or otherwise control the conductivity of the electrical connection formed by the electrical connections between the contact slip housings 708 and collar electrical leads 709. An increase of conductivity between the contact slip housings 708 and collar electrical leads 709 can provide for relatively high power draw applications. Depending on the orientation and arrangement of a linear electrical contact slip, the collar electrical leads 709 can be a part of either uphole electrical leads or downhole electrical leads. In further aspects, the embedded collar wiring 711 can be an electrically conductive element such as a filament, an electrical bridge, an electrical tangency, or other metallic connection between a contact slip housing 708 and a collar electrical lead 709.

The collar structure 700 is further formed to have a hollow space, referred to as a collar core 706, in which a piston structure can reside and move with a linear motion. Due to the designed architecture of the collar core 706 in the collar structure 700, electrically non-conductive hydraulic oil can pass through the collar structure 700 (and around any piston structure) in uphole and downhole directions. Therefore, the linear electrical contact slip of the present disclosure does not experience any pressure differential between the uphole end and downhole end of the collar structure 700. Similarly, the linear electrical contact slip of the present disclosure does not experience any pressure differential between the collar core 706 of the collar structure 700 and the region of a wellbore surrounding the collar structure 700. Accordingly, the linear electrical contact slip of the present disclosure can withstand the high pressures experienced in oil-filled wellbore applications without the need to actively control the pressure of the electrical contact regions, and without concern of structural collapse or failure of the linear electrical contact slip due to high pressures.

FIG. 7B is an end-view cross-sectional schematic diagram of a piston structure 714 of a linear electrical contact slip configured to have three groupings of electrical contacts, where each grouping includes four electrical contacts. Specifically illustrated in cross-section is a piston head 716, which can be made of an engineering plastic similar to the material used to form the collar body 704, having strong electrical insulator properties and chemical resistance and can further withstand high temperatures with minimum distortion as found in a wellbore environment. The piston head 716 can contain components extending outward from the centerline of the piston head 716 (and by extension, from the longitudinal axis of a connected piston shaft) including one or more piston electrical contacts 718 and one or more key projections 720. The one or more piston electrical contacts 718 can be formed by over-molding a projected section of the piston head 716 with a conductive metal, or by inserting and attaching separate electrically conductive elements to the surface of the piston head 716. In some aspects, the formation of the one or more piston electrical contacts 718 by over-molding a portion of the piston head can have a stronger bond than attaching separate electrically conductive elements to the surface of the piston head 716, and the method of forming the piston structure 714 can be selected accordingly depending on design requirements, or the need to replace any individual piston electrical contact 718.

The piston structure 714 can further electrically couple the piston electrical contacts 718 to piston electrical leads 719 via embedded piston wiring 717 embedded within the piston structure 714. In some aspects, each piston electrical contact 718 can be coupled through embedded piston wiring 717 to a single piston electrical lead 719. In other aspects, two or more piston electrical contacts 718 can be coupled through embedded piston wiring 717 to a piston electrical lead 719. In further aspects, the piston electrical leads 719 can further connect to the a conductive metal housing 722 surrounding the interior surface of the piston structure 714, and which can define a hollow space, referred to as a piston core 724, of the piston head 716 and connected piston shaft. Either or both of the piston electrical leads 719 and conductive metal housing 722 can extend along the piston shaft to a terminus at an opposing end of the piston. Depending on the orientation and arrangement of a linear electrical contact slip, the piston electrical leads 719 can be a part of either uphole electrical leads or downhole electrical leads. In further aspects, the embedded piston wiring 717 can be an electrically conductive element such as a filament, an electrical bridge, an electrical tangency, or other metallic connection between a piston electrical contact 718 and a piston electrical lead 719.

Considered in combination, FIG. 7A and FIG. 7B illustrate the interaction and coupling of both the key projections 720 with the keyways 710 and the piston electrical contacts 718 with the canted coils 712. In some aspects, the piston structure 714 can fit within the collar core 706 of the collar structure 700, such that the piston structure 714 and piston head 716 can move linearly along the longitudinal axis of the collar structure 700. The keyways 710 of the collar structure 704 are in part an extension of the collar core 706, providing passages for key projections 720 on the piston structure 714. The arrangement of the key projections 720 and the keyways 710 allow for linear motion along the longitudinal axes of the collar structure 700 and piston structure 714, and further operate to prevent rotation of the piston structure 714 within the collar core 706 of the collar structure 700, or vice versa. In some aspects, either or both of the key projections 720 and the keyways 710 can be considered antirotational features. Rotation of either the collar structure 700 or the piston structure 714 could result in an electrical short circuit or a loss of electrical communication between electrically conductive elements of the collar structure 700 and the piston structure 714. As illustrated in FIG. 7A and FIG. 7B, the piston structure 714 can have three key projections 720 that extend into three corresponding keyways 710 molded into the collar body 704 of the collar structure 700.

As further illustrated in FIG. 7A and FIG. 7B, the piston structure 714 can have three groupings of piston electrical contacts 718, where each grouping has four individual piston electrical contacts 718 (resulting in a total of twelve electrical couplings between the piston structure 714 and collar structure 700). Each piston electrical contact 718 has a corresponding canted coil 712 secured within contact slips housings 708 of the collar structure 700, forming individual pairings of piston electrical contacts 718 with canted coils 712. Accordingly, as either a piston structure 714 or a collar structure 700 moves linearly with respect to the other, the length of each piston electrical contact 718 remains in electrical communication with a corresponding canted coil 712, allowing for the conduction of electricity as either of the piston structure 714 or collar structure 700 moves. While stationary or in motion, the connection between the piston electrical contacts 718 and canted coils 712 can provide for stable and consistent passage of current of up to thirty Amperes (30 A). The amount of electricity conducted can be distributed across the twelve electrical couplings illustrated. If any one or more of the electrical couplings disconnects, shorts, or fails, the remaining electrical couplings can provide for the continued transmission of the same amount of current prior to the one or more of the electrical coupling failures.

While FIGS. 4A and 4B, FIGS. 5A and 5B, FIGS. 6A and 6B, and FIGS. 7A and 7B provide examples of the present disclosure having particular arrangements of key projection with keyways and particular arrangements of piston electrical contacts with canted coils, further aspects of the present disclosure can be directed to piston and collar structures having two, three, four, or five or more key projection and keyways arrangements in combination with two, three, four, or five or more groupings of piston electrical contacts with canted coils, where the groupings of piston electrical contacts with canted coils can have two, three, four, or five or more pairings of individual piston electrical contact and canted coil in each grouping. In some aspects, the diameter of any given paired piston and collar structure, which determines the space available along the interior diameter of the collar structure, can guide the number of electrical contact regions used by the paired piston and collar structure.

In some aspects, the present disclosure is directed to a linear electrical contact slip structure of a tool string, having: a piston structure, coupled to an uphole tool string section having uphole electrical leads, the piston structure providing one or more piston electrical contact regions that are electrically coupled to the uphole electrical leads; a collar structure, coupled to a downhole tool string section having downhole electrical leads, the collar structure providing one or more collar electrical contact regions that are electrically coupled to the downhole electrical leads; the one or more piston electrical contact regions and the one or more collar electrical contact regions arranged to maintain electrical communication where either of the piston structure or the collar structure are stationary or in motion. In particular aspects, the piston structure can be a stroker section and the collar structure can be a stator section. In alternative aspects, the collar structure can be a stroker section and the piston structure can be a stator section. In some aspects, the piston structure can have one or more key projections and one or more piston electrical contact regions, where the collar structure can have one or more keyways and one or more collar electrical contact regions. In other aspects, the piston structure can have three key projections and three groupings of piston electrical contact regions, where the collar structure can have three keyways and three groupings of collar electrical contact regions. In alternative aspects, the piston structure can have four key projections and four piston electrical contact regions, where the collar structure has four keyways and four collar electrical contact regions. In further aspects, the piston structure can have three key projections and two piston electrical contact regions, where the collar structure has three keyways and two collar electrical contact regions. In yet further aspects, the piston structure can have three key projections and four piston electrical contact regions, where the collar structure has three keyways and four collar electrical contact regions. In further aspects, one or more collar electrical contact regions can be canted coils.

In other aspects, the present disclosure is directed to a linear electrical contact slip structure of a tool string, having: a collar structure, coupled to an uphole tool string section having uphole electrical leads, the collar structure providing one or more collar electrical contact regions that are electrically coupled to the uphole electrical leads; a piston structure, coupled to a downhole tool string section having downhole electrical leads, the piston structure providing one or more piston electrical contact regions that are electrically coupled to the downhole electrical leads; the one or more collar electrical contact regions and the one or more piston electrical contact regions arranged to maintain electrical communication where either of the collar structure or the piston structure are stationary or in motion. In particular aspects, the piston structure can be a stroker section and the collar structure can be a stator section. In alternative aspects, the collar structure can be a stroker section and the piston structure can be a stator section. In some aspects, wherein the piston structure can have one or more key projections and one or more piston electrical contact regions, where the collar structure can have one or more keyways and one or more collar electrical contact regions. In other aspects, the piston structure can have three key projections and three groupings of piston electrical contact regions, where the collar structure can have three keyways and three groupings of collar electrical contact regions. In alternative aspects, the piston structure can have four key projections and four piston electrical contact regions, where the collar structure can have four keyways and four collar electrical contact regions. In further aspects, the piston structure can have three key projections and two piston electrical contact regions, where the collar structure has three keyways and two collar electrical contact regions. In yet further aspects, the piston structure can have three key projections and four piston electrical contact regions, where the collar structure has three keyways and four collar electrical contact regions. In some aspects, one or more collar electrical contact regions can be canted coils.

In further aspects, the present disclosure is directed to a system for conducting electricity across a linear electrical contact slip structure, where the system has: a stator section, electrically coupled to a first set of electrical leads; a stroker section, mechanically coupled to the stator section and arranged to move within a range of motion relative to the stator section, and electrically coupled to a second set of electrical leads; where the first set of electrical leads pass through the stator section, and where the second set of electrical leads pass through the stroker section, such that the first set of electrical leads and the second set of electrical leads are electrically coupled and maintain electrical communication while the stroker section is either stationary or in motion. In some aspects, the motion of the stroker section relative to the stator section can be linear. In other aspects, the motion of the stroker section can be controlled to not rotate relative to the stator section. In further aspects, a current of up to 30 A can be conducted through the linear electrical contact slip structure. In some aspects, where the stroker section can be a piston structure that can be actuated to move relative to a collar structure that is a stator section. In other aspects, the stroker section can be a collar structure that can be actuated to move relative to a piston structure that is the stator section.

The subject matter of aspects and examples of this patent is described here with specificity to meet statutory requirements, but this description is not necessarily intended to limit the scope of the claims. The claimed subject matter may be embodied in other ways, may include different elements or steps, and may be used in conjunction with other existing or future technologies. Throughout this description for the purposes of explanation, numerous specific details are set forth in order to provide a thorough understanding of examples and aspects of the subject matter disclosed herein. It will be apparent, however, to one skilled in the art that the many examples or aspects may be practiced without some of these specific details. In some instances, structures and devices are shown in diagram or schematic form to avoid obscuring the underlying principles of the described examples or aspects. This description should not be interpreted as implying any particular order or arrangement among or between various steps or elements except when the order of individual steps or arrangement of elements is explicitly described.

With these aspects in mind, it will be apparent from this description that aspects of the described techniques may be embodied, at least in part, in software, hardware, firmware, or any combination thereof. It should also be understood that aspects can employ various computer-implemented functions involving data stored in a data processing system. That is, the techniques may be carried out in a computer or other data processing system in response executing sequences of instructions stored in memory. In various aspects, hardwired circuitry may be used independently, or in combination with software instructions, to implement these techniques. For instance, the described functionality may be performed by specific hardware components, such as a control unit for actuating a stroker section of a tool string system, containing hardwired logic for performing operations, or by any combination of custom hardware components and programmed computer components. The techniques described herein are not limited to any specific combination of hardware circuitry and software.

The foregoing description of the disclosure, including illustrated aspects and examples has been presented only for the purpose of illustration and description and is not intended to be exhaustive or to limit the disclosure to the precise forms disclosed. Numerous different modifications, adaptations, and arrangements of the components depicted in the drawings or described above, as well as components and steps not shown or described, are possible. Similarly, some features and subcombinations are useful and may be employed without reference to other features and subcombinations. Examples and aspects of the subject matter have been described for illustrative and not restrictive purposes, and alternative examples or aspects will become apparent to those skilled in the art without departing from the scope of this disclosure. Accordingly, the present subject matter is not limited to the examples or aspects described above or depicted in the drawings, and various embodiments, examples, aspects, and modifications can be made without departing from the scope of the claims below.

That which is claimed is:

1. A linear electrical contact slip structure of a tool string, comprising:
a piston structure, coupled to an uphole tool string section having uphole electrical leads, the piston structure providing one or more piston electrical contact regions that are electrically coupled to the uphole electrical leads; and
a collar structure, coupled to a downhole tool string section having downhole electrical leads, the collar structure providing one or more collar electrical contact regions that are electrically coupled to the downhole electrical leads, where the one or more piston electrical contact regions and the one or more collar electrical contact regions arranged to maintain electrical communication where either of the piston structure or the collar structure are stationary or in motion.

2. The linear electrical contact slip according to claim 1, wherein the piston structure is a stroker section and the collar structure is a stator section.

3. The linear electrical contact slip according to claim 1, wherein the collar structure is a stroker section and the piston structure is a stator section.

4. The linear electrical contact slip according to claim 1, wherein the piston structure has one or more key projections and one or more piston electrical contact regions, and wherein the collar structure has one or more keyways and one or more collar electrical contact regions.

5. The linear electrical contact slip according to claim 4, wherein the piston structure has three key projections and three groupings of piston electrical contact regions, and wherein the collar structure has three keyways and three groupings of collar electrical contact regions.

6. The linear electrical contact slip according to claim 4, wherein the piston structure has three key projections and four piston electrical contact regions, and wherein the collar structure has three keyways and four collar electrical contact regions.

7. The linear electrical contact slip according to claim 1, wherein one or more collar electrical contact regions are canted coils.

8. A linear electrical contact slip structure of a tool string, comprising:
a collar structure, coupled to an uphole tool string section having uphole electrical leads, the collar structure providing one or more collar electrical contact regions that are electrically coupled to the uphole electrical leads; and
a piston structure, coupled to a downhole tool string section having downhole electrical leads, the piston structure providing one or more piston electrical contact regions that are electrically coupled to the downhole electrical leads, where the one or more collar electrical contact regions and the one or more piston electrical contact regions arranged to maintain electrical communication where either of the collar structure or the piston structure are stationary or in motion.

9. The linear electrical contact slip according to claim 8, wherein the piston structure is a stroker section and the collar structure is a stator section.

10. The linear electrical contact slip according to claim 8, wherein the collar structure is a stroker section and the piston structure is a stator section.

11. The linear electrical contact slip according to claim 8, wherein the piston structure has one or more key projections and one or more piston electrical contact regions, and wherein the collar structure has one or more keyways and one or more collar electrical contact regions.

12. The linear electrical contact slip according to claim 11, wherein the piston structure has three key projections and three groupings of piston electrical contact regions, and wherein the collar structure has three keyways and three groupings of collar electrical contact regions.

13. The linear electrical contact slip according to claim 11, wherein the piston structure has three key projections and four piston electrical contact regions, and wherein the collar structure has three keyways and four collar electrical contact regions.

14. The linear electrical contact slip according to claim 8, wherein one or more collar electrical contact regions are canted coils.

15. A system for conducting electricity across a linear electrical contact slip structure, comprising:
a stator section, electrically coupled to a first set of electrical leads;
a stroker section, mechanically coupled to the stator section and arranged to move within a range of motion relative to the stator section, and electrically coupled to a second set of electrical leads;
where the first set of electrical leads pass through the stator section, and where the second set of electrical leads pass through the stroker section, such that the first set of electrical leads and the second set of electrical leads are electrically coupled and maintain electrical communication while the stroker section is either stationary or in motion.

16. The system according to claim 15, wherein the motion of the stroker section relative to the stator section is linear.

17. The system according to claim 15, wherein the motion of the stroker section is controlled to not rotate relative to the stator section.

18. The system according to claim 15, wherein a current of up to 30 A is conducted through the linear electrical contact slip structure.

19. The system according to claim 15, wherein the stroker section is a piston structure, actuated to move relative to a collar structure that is the stator section.

20. The system according to claim 15, wherein the stroker section is a collar structure, actuated to move relative to a piston structure that is the stator section.
